(19) United States
(12) Patent Application Publication
(10) Pub. No.: US 2008/0040435 A1
(43) Pub. Date: Feb. 14, 2008

(54) METHOD AND SYSTEM FOR PERSONALIZING AN E-MAIL SIGNATURE

(76) Inventors: Giovanni Buschi, Nice (FR); Beatrice Coulomb, Cagnes sur Mer (FR); Apollonie Sbragia, Antibes Juan Les Pins (FR); Carole Truntschka, Saint-Laurent-Du-Var (FR)

Correspondence Address: HOFFMAN, WARNICK & D'ALESSANDRO LLC, 75 STATE ST, 14 FL, ALBANY, NY, 12207, US

(21) Appl. No.: 11/745,607

(22) Filed: May 8, 2007

(30) Foreign Application Priority Data
Aug. 11, 2006 (EP) 06118821.5

(51) Int. Cl. G06F 15/16

(52) U.S. Cl. 709/206

(57) ABSTRACT

A method and system for personalizing e-mail signatures is disclosed. A method for generating personalized signed electronic mails to be sent from a client side to a server side of an electronic mail (e-mail) application in accordance with an embodiment of the present invention includes: creating a plurality of recipient categories; associating e-mail application environment information with the plurality of recipient categories to create a set of conditional rules; using the set of conditional rules to create a plurality of signatures; creating an e-mail having a recipient address and message text, inserted in a respective address field and text field; searching the plurality of signatures to find a signature matching the recipient address; and transmitting the e-mail to the recipient address with the matching signature inserted in a signature field of the e-mail.

### FIELD OF THE INVENTION

The present invention generally relates to the field of computer-based mail or electronic mail (e-mail), and more particularly to a method and system for personalizing an e-mail signature.

### BACKGROUND OF THE INVENTION

E-mail is widely used by almost anyone with a computer and network connection. Most e-mail systems are based on Internet standards, the main standards being the Post Office Protocol (POP, RFC 1939) for receiving e-mail and the Simple Mail Transport Protocol (SMTP, RFC 2821) for sending e-mail.

The SMTP standard describes how to specify destinations for e-mail. A destination is simply an e-mail address, such as “jdoe@example.net”. A distribution list contains two or more destinations, e.g., the distribution list “team” might represent destinations “jdoe@example.net, jsmith@example.net”.

On the basis of the SMTP model, a user that generates a simple e-mail composes the text of the message and provides additional information which will be sent in a header of the message. In this case, the e-mail author indicates the sender address (namely the ‘From:’ field in the e-mail header), the recipient address(es) (the ‘To:’ field) which may be the address of the final recipient, the address(es) of people to be copied (the ‘Cc:’ field) and the address(es) of people to be blind carbon copied (the ‘Bcc:’ field). The “Bcc:” field contains addresses of recipients of the message whose addresses are not to be revealed to other recipients of the message.

Additionally, SMTP offers function for simplifying the management of the addresses, mainly based on the concept of directories and distribution lists. Directories which are either a general shared directory or local address books, contain distribution lists which facilitate the sending of e-mails to multi-recipients. According to SMTP, a mailbox is a virtual entity which receives e-mail for a recipient: when it is desirable to treat several mailboxes as a single unit (i.e., in a distribution list), a group construct function is used. The group construct function allows a sender to indicate a named group of recipients without actually providing the individual mailbox address for each of those recipients. When the sender creates the message, he/she can enter the name of the distribution list and then, automatically, the e-mail application operating on its workstation creates a message for each member found in the list at the envelope level. The header of the message contains the name of the list which later is then expanded into a corresponding number of messages by SMTP.

Frequently, a sender preparing a message may have to compose e-mail for several recipients belonging to different organizations, either internally or outside of his/her company. The information included in the e-mail signature generally includes information relative to the sender such as his/her intranet address, internal responsibility, and/or information regarding his/her own business organization. This information is not necessarily appropriate for all the recipients and may not need to be used or sent to each recipient.

One drawback with today's e-mail is the lack of function and control in sending an identical e-mail to many destinations at once while including different e-mail signatures. With conventional e-mail systems, this requirement requires a tedious, error prone, manual process where the e-mail originator must, for example:

First send to the recipients belonging to his/her organization the message along with an internal signature;

Then, manually build a second signature different from the internal signature, where confidential and/or other information is removed; and

Send a second message derived from the first message along with the second signature to the appropriate recipients.

Similarly, additional signatures may be generated if further distribution lists are necessary. Clearly, such an iterative process is time consuming and not user friendly.

Thus, there is a need not answered by existing e-mail systems to facilitate and optimize e-mail generation when a common message is to be sent to different recipients that require different e-mail signatures.

### SUMMARY OF THE INVENTION

The present invention provides a method and system for personalizing an e-mail signature which overcomes these and other issues of the prior art.

According to a first aspect of the present invention, a method executed on a client side of an electronic mail (e-mail) application for generating personalized signed e-mail to be sent from the client side to a server side of the e-mail application is provided. The method comprises: creating a plurality of recipient categories; associating e-mail application environment information with the plurality of recipient categories to create a set of conditional rules; using the set of conditional rules to create a plurality of signatures; creating an e-mail having a recipient address and message text, inserted in a respective address field and text field; searching the plurality of signatures to find a signature matching the recipient address; and transmitting the e-mail to the recipient address with the matching signature inserted in a signature field of the e-mail.

In an alternative implementation, computer readable program means to operate the steps of the aforementioned method is embodied on a program storage device that is readable by a computer machine.

### BRIEF DESCRIPTION OF THE DRAWINGS

These and other features of this invention will be more readily understood from the following detailed description of the various aspects of the invention taken in conjunction with the accompanying drawings.

FIG. 1 illustrates a computing environment for implementing a method in accordance with an embodiment of the present invention.

FIG. 2 depicts details of the logical programming blocks forming a client e-mail application in accordance with an embodiment of the present invention.

FIG. 3 depicts the preparation of three (3) e-mails in only one e-mail generation and sending operation in accordance with an embodiment of the present invention.

FIG. 4 depicts a flowchart of an illustrative process for generating personalized e-mails in accordance with an embodiment of the present invention.

FIG. 5 is a pictorial representation of a user interface main window in accordance with an embodiment of the present invention.

### DETAILED DESCRIPTION OF THE INVENTION

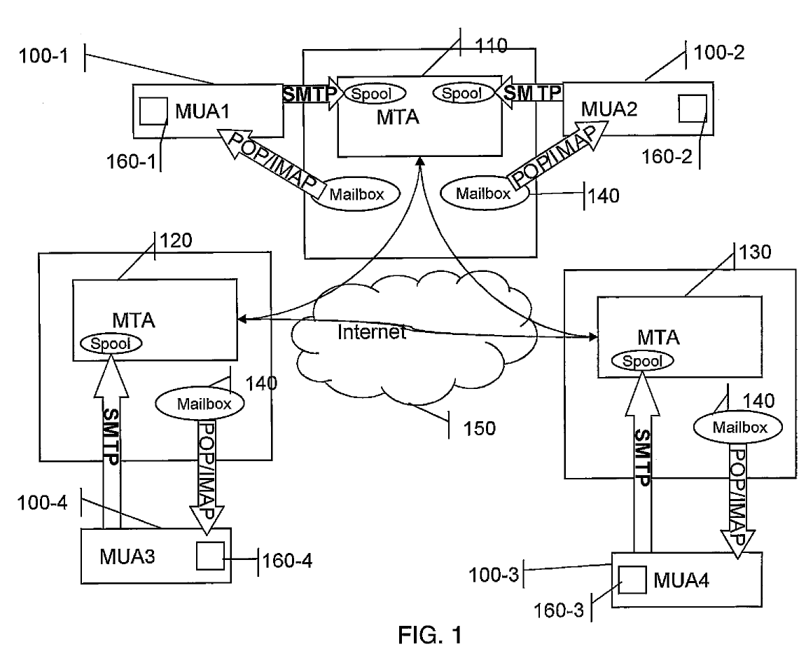

Referring first to FIG. 1, there is illustrated a block diagram of a computing SMTP environment in accordance with an embodiment of the present invention.

In the SMTP model as defined in the RFC 2821, mail user agents (MUAs 100-i) operating in user workstations act as clients for their respective mail servers, also called mail transfer agents (MTAs (110,120,130)). In the present example, mail user agents MUA1 and MUA2 are connected to the same mail transfer agent MTA 110, while mail user agents MUA3 and MUA4 are each connected to their respective MTAs 120, 130. The MTAs are in charge of managing recipient e-mail addresses by transferring and receiving e-mails to and from either local mail user agents or from remote mail user agents over the Internet network 150. In operation, a mail user agent sends an e-mail, which includes message data and the recipient names, to its local MTA. Then, to deliver the e-mail to a local mail user agent, the MTA looks for the addresses of the recipients and deposits the mail in the mailbox 140-i of each mail user agent which is a recipient for the e-mail. The sender and recipient names correspond to their respective mailbox identifiers.

The MUAs further comprise a selective signature generator block (SSG) 160-i to allow the user of the mail user agent 100 to automatically generate an e-mail with as many personalized signatures as required according to the method of the present invention.

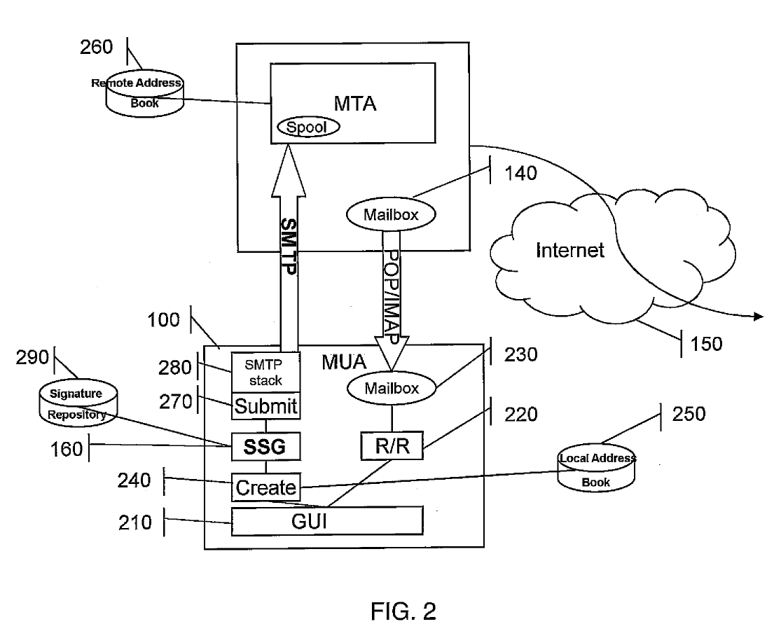

Referring now to FIG. 2, the details of the logical programming blocks forming the client e-mail application according to the invention are now described.

To send and receive e-mails for a user, the client mail application comprises a mail user agent 100 interfaced to the user with a graphical user interface (GUI) 210 and comprising at least the following functions:

### A) A read/retrieve (R/R) function 220 which allows access to the mailbox 230 where messages are saved and stored according to RFC 2882;

### B) A create mail function 240 which allows access to either a local address book 250 or to a remote address book 260 located on a MTA;

### C) A submit mail function 270 to submit the e-mail in a format compliant with RFC 2822;

### D) A SMTP stack 280 to transfer the e-mail in a valid format to the MTA via SMTP; and

E) A selective signature generator (SSG) 160. The SSG 160 allows the user of the mail user agent 100 to generate via the GUI 210 the text of the message, the recipients lists, and various elements such as the e-mail subject. The SSG 160 further retrieves appropriate e-mail signatures from a signature repository 290 and associates each signature to a recipient list according to rules predefined by the user and stored in the signature repository 290. The SSG 160 generates e-mails that the submit mail function then handles.

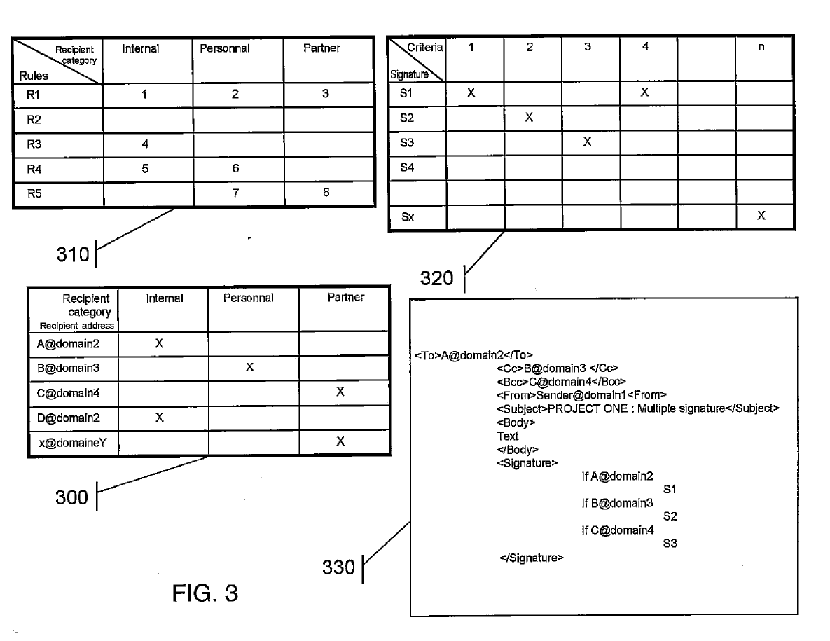

Referring now to FIG. 3, the rules repository and signatures repository that allow personalized signatures to be defined and stored according to recipient's category are described using the example of the preparation of three e-mails. An illustrative process in which only one message is prepared by the user and three personalized e-mail's are submitted to SMTP through the submit function is described, with each e-mail having a personalized signature that is determined and included in the e-mail in the manner described below. Of course, any number of e-mails having personalized signatures can be generated by the present invention.

As shown in FIG. 3, a first table 300 (called the recipient table) contains recipient addresses shown in the rows (A@domain2, B@domain3, . . . ) and recipient categories shown in the columns (internal, personal, partner). The categories are defined by the user and include, in this example, “internal” for colleagues, “personal” for private contacts, and “business partner” for commercial contacts. In general, any type of category can be defined by a user.

A second table 310 (called the rules table) contains a set of rules (R1, . . . , Rn) that are defined by the user, in correspondence with the recipient's categories. The rules define the general environment of the e-mail taking into account the category of the recipient(s), the subject-matter, the nature of the connection, and the like. As an example, a rule R1 may be defined as being: “If recipient category is equal to “internal” and recipient is also in category “personal” then criteria 1 is applied else criteria 8 is applied”.

It is to be appreciated that the rules are not to be limited to those described herein, and that the user may define any type of personalized rules. The rules table 310 allows the user to define the criteria that is/are used by a signature table 320 to select the appropriate signature to be inserted in each e-mail.

A third table 320 (called the signature table) establishes links between the criteria defined in the rules table 310 and the model of signature (S1, S2, . . . ) to be inserted for each recipient of the e-mail.

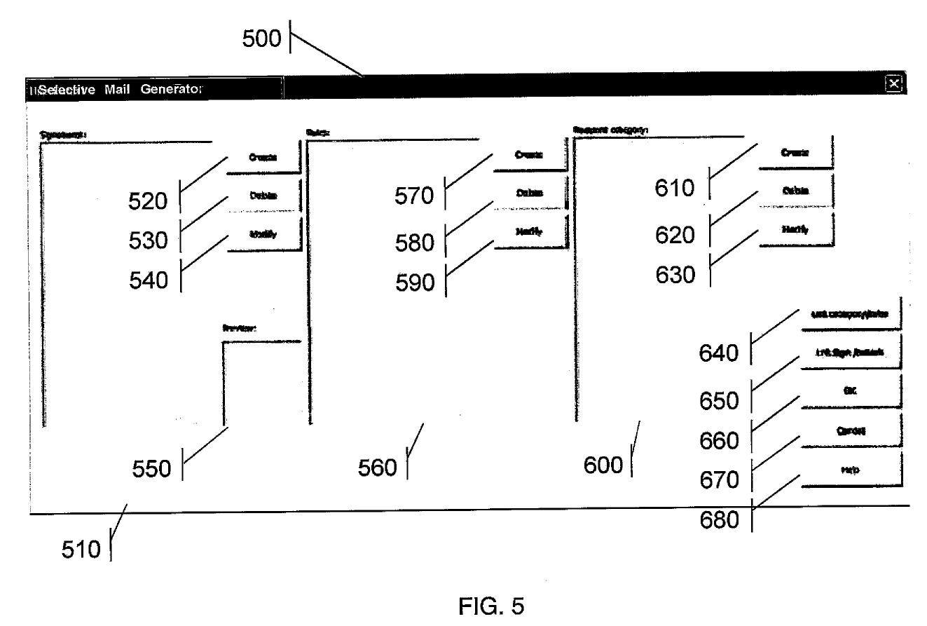

In operation, the user first enters the text of the message in a text zone, enters the name of each recipient (“Sent to” list or distribution list) of the message in the recipient zone, and optionally fills in the subject matter of the e-mail in the subject zone. Then, the user either directly submits the e-mail if signatures have previously been created and stored, or the user defines a new set of rules and signatures to be used for this e-mail. The creation or modification of rules and signatures is accomplished through the GUI 210. A more detailed description of the GUI 210 used by the present invention is given below with reference to FIG. 5.

As shown in view 330 of FIG. 3, conventional tags are preferably used for the programming, such as XML tags for instance, to define the beginning and the end of a signature zone of an e-mail. A message has then the following format:

<To>A@domain2</To>
<Cc>B@domain3</Cc>
<Bcc>C@domain4</Bcc>
<From>Sender@domain1<From>
<Subject>PROJECT ONE : Multiple signature</Subject>
<Body>
Text
</Body>
<Signature>
Signature
</Signature>

In the present example, the message contains 3 recipients or distribution lists. Recipient ‘A’ is a SMTP primary recipient, and defined between tags <to ></to>; recipient ‘B’ is in copy and defined between tags <Cc></cc>; and recipient ‘C’ is in hidden copy and defined between tags <Bcc></Bcc>. The subject of the e-mail is defined between tags <Subject</Subject>. The text of the message is defined between tags <Body></Body>. The signature(s) is(are) defined between tags <Signature></Signature>. The signature may be any kind of element in any format such as text, images, HTML, etc.

Once the e-mail is submitted, the SSG 160 retrieves the category of recipient associated with each recipient address in the recipient table 300, and retrieves from the rules table 310 the rule to be applied to the specific category. For example: “If the mail subject contains the sentence “PROJECT ONE”, and if the recipient's category is ‘a’, then criteria is ‘1’, else if recipient's category is ‘b’, then criteria is ‘2’, else if recipient's category is ‘c’, then criteria is ‘3’.” Once, the rule is found and the corresponding criterion determined, the SSG 160 retrieves the signature to be used for this recipient from the signature table 320. Finally, the SSG 160 generates a unique message (e.g., as shown in view 330) to be used by the submit function 270, that contains the appropriate signatures for each recipient. For example, the SSG 160 can generate the unique message:

```
<To>A@domain2</To>
<Cc>B@domain3</Cc>
<Bcc>C@domain4</Bcc>
<From>Sender@domain1<From>
<Subject>PROJECT ONE : Multiple signature</Subject>
<Body>
Text
</Body>
<Signature>
  If A@domain2
    S1
  If B@domain3
    S2
  If C@domain4
    S3
</Signature>
```

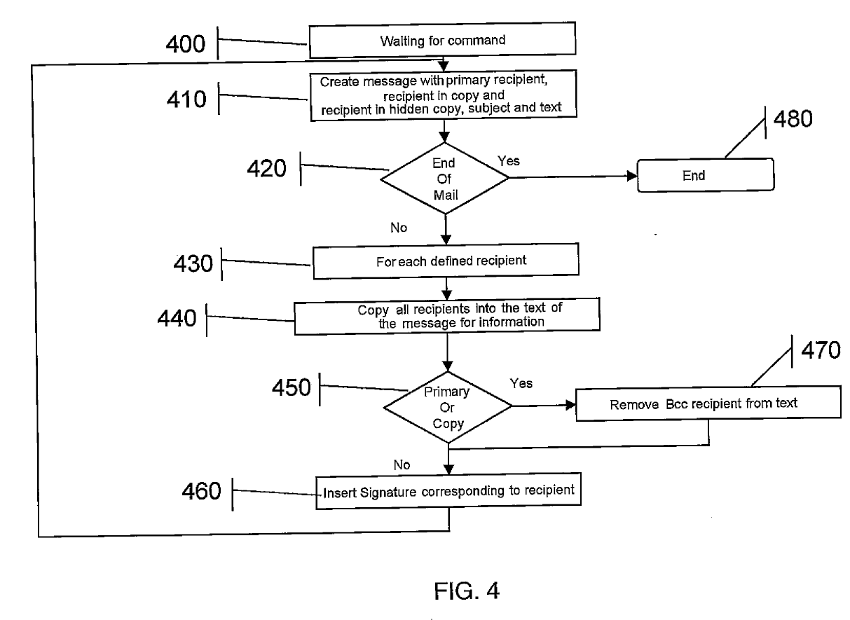

FIG. 4 is a flowchart of a process used by the SSG 160 to generate the above-listed message according to an embodiment of the present invention.

In 400, the submit function starts on a SSG request when the message prepared by the user is ready. In 410, a message is created except for the signature section.

If, in 420 the end of the e-mail is reached, the process ends in 480, otherwise the process continues with 430. In 430, a loop is started for each defined recipient. In 440, all the destination recipients are copied into the text area of the e-mail. The text generated for the initial message becomes at this stage:

<Body>
To: A@domain2
Cc: B@domain3
Bcc: C@domain4
Text
</Body>

Next, in 450, the process checks if the recipient is stated as a primary recipient or a copy recipient. If YES in 450, the process removes the Bcc line from the message in 470, otherwise flow passes to 460. In the previous example, the text generated for the message becomes:

<Body>
To: A@domain2
Cc: B@domain3
Text
</Body>

Then the process continues in 460 (either coming from branch NO of 450 or from 470) with the insertion of the correct signature corresponding to the designated recipient. Finally, the process loops back to 410. In 420, if the end of the e-mail is reached, meaning that all recipients have been parsed and the signatures inserted, the process ends, otherwise a new iteration is started.

FIG. 5 shows a pictorial representation of an illustrative embodiment of the main window 500 of the GUI 210.

The window 500 includes a signature area (510), a rules area (560), a recipient category area (600), and push buttons to create the links between the recipient category and a rule (640), the link between the criteria and the signature (650), and additional buttons (OK 660, cancel 670, and help 680).

The signature area 510 displays a list of preexisting or newly created signatures. The user may select a predefined signature in this selection list or create 520 a new one. The user is also offered the possibility to delete 530 or modify 540 a signature. Thus, the main window 500 includes several push buttons to manage the signatures: a create button 520 to create a new signature, which is then displayed in the signature area 510; a delete button 530 to delete a signature selected in the signature area 510; and a modify button 540 to modify a preselected signature in the signature area 510.

The main window 500 further includes a preview area 550 to preview the signature selected in the signature area 510.

A second area, called the rules area 560, displays the list of rules to be managed. The user may select one predefined rule in this selection or use a push button to manage the rules: a create button 570 to create a new rule, which is then displayed into the rule area 560; a delete button 580 to delete a rule selected in the rule area 560; and a modify button 590 to modify a preselected rule in the rule area 560.

A third area, called the recipient category area 600, displays the list of the recipient's categories to be managed. The user may select one recipient category in the recipient category area 600. The main window 500 also includes several push buttons to manage the categories: a create button 610 to create a new recipient category which is then displayed in the recipient category area 600; a delete button 620 to delete a recipient category selected in the recipient category area 600; and a modify button 630 to modify a preselected recipient category in the recipient category area 600.

The main window 500 further includes push buttons to manage the links between the different elements: a link categories/rules button 640 to manage the content of the recipient table; a link signature/criteria button 650 to manage the content of the signature table; an OK button 660 to validate all actions performed via the SSG and exit the signature GUI; and a cancel button 670 to ignore the actions and exit the SSG.

The main window 500 may also include a Help button 680 to start a help process for the external interface.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

It should be appreciated that the teachings of the present invention could be offered as a business method on a subscription or fee basis. For example, a service provider can create, maintain, enable, and deploy an audience response detection interactive presentation tool, as described above.

The foregoing description of the embodiments of this invention has been presented for purposes of illustration and description. It is not intended to be exhaustive or to limit the invention to the precise form disclosed, and many modifications and variations are possible.

1. A method executed on a client side of an electronic mail (e-mail) application for generating personalized signed electronic mails to be sent from the client side to a server side of the e-mail application, comprising:
creating a plurality of recipient categories;
associating e-mail application environment information with the plurality of recipient categories to create a set of conditional rules;
using the set of conditional rules to create a plurality of signatures;
creating an e-mail having a recipient address and message text, inserted in a respective address field and text field;
searching the plurality of signatures to find a signature matching the recipient address; and
transmitting the e-mail to the recipient address with the matching signature inserted in a signature field of the e-mail.

2. The method of claim 1, wherein the e-mail has a plurality of recipient addresses, further comprising:
searching the plurality of signatures to find a signature matching each of the plurality of recipient addresses; and
transmitting the e-mail to each of the plurality of recipient addresses with the respective matching signature inserted in a signature field of the e-mail.

3. The method of claim 1, wherein the set of conditional rules further include subject-matter e-mail conditions, and wherein creating an electronic mail further comprises:
inserting a subject-matter for the e-mail in a subject field.

4. The method of claim 1, further comprising:
storing at least one of the plurality of recipient categories, the set of conditional rules, and the plurality of signatures.

5. The method of claim 4, further comprising:
updating any of the stored plurality of recipient categories, the set of conditional rules, and the plurality of signatures.

6. The method of claim 1, wherein the recipient address includes an address of at least one primary recipient and at least one copy recipient.

7. The method of claim 1, wherein the recipient address includes an address of at least one blind copy recipient.

8. The method of claim 1, wherein the recipient address is a distribution list having a plurality of recipient addresses.

9. The method of claim 1, wherein the e-mail application is operated in a Simple Mail Transport Protocol (SMTP) environment.

10. A system for generating personalized signed electronic mails to be sent from a client side to a server side of an electronic mail (e-mail) application, comprising:
a system for creating a plurality of recipient categories;
a system for associating e-mail application environment information with the plurality of recipient categories to create a set of conditional rules;
a system for using the set of conditional rules to create a plurality of signatures;
a system for creating an e-mail having a recipient address and message text, inserted in a respective address field and text field;
a system for searching the plurality of signatures to find a signature matching the recipient address; and
a system for transmitting the e-mail to the recipient address with the matching signature inserted in a signature field of the e-mail.

11. The system of claim 10, wherein the e-mail has a plurality of recipient addresses, further comprising:
a system for searching the plurality of signatures to find a signature matching each of the plurality of recipient addresses; and
a system for transmitting the e-mail to each of the plurality of recipient addresses with the respective matching signature inserted in a signature field of the e-mail.

12. The system of claim 10, wherein the set of conditional rules further include subject-matter e-mail conditions, and wherein the system for creating an electronic mail further comprises:
a system for inserting a subject-matter for the e-mail in a subject field.

13. The system of claim 10, further comprising:
a system for storing at least one of the plurality of recipient categories, the set of conditional rules, and the plurality of signatures.

14. The system of claim 13, further comprising:
a system for updating any of the stored plurality of recipient categories, the set of conditional rules, and the plurality of signatures.

15. The system of claim 10, wherein the recipient address includes an address of at least one primary recipient and at least one copy recipient.

16. The system of claim 10, wherein the recipient address includes an address of at least one blind copy recipient.

17. The system of claim 10, wherein the recipient address is a distribution list having a plurality of recipient addresses.

18. The system of claim 10, wherein the e-mail application is operated in a Simple Mail Transport Protocol (SMTP) environment.

19. A program product stored on a computer readable medium, which when executed, generates personalized signed electronic mails to be sent from a client side to a server side of an e-mail application, the computer readable medium comprising program code for:
creating a plurality of recipient categories;
associating e-mail application environment information with the plurality of recipient categories to create a set of conditional rules;
using the set of conditional rules to create a plurality of signatures;
creating an e-mail having a recipient address and message text, inserted in a respective address field and text field;
searching the plurality of signatures to find a signature matching the recipient address; and
transmitting the e-mail to the recipient address with the matching signature inserted in a signature field of the e-mail.
